(19) United States
(12) Patent Application Publication
(10) Pub. No.: US 2010/0084917 A1
(43) Pub. Date: Apr. 8, 2010

(54) Power adaptor

(76) Inventor: Cheng-Fong Tsao, Apia (WS)

Correspondence Address: ROSENBERG, KLEIN & LEE, 3458 ELLICOTT CENTER DRIVE-SUITE 101, ELLICOTT CITY, MD, 21043, US

(21) Appl. No.: 12/588,062

(22) Filed: Oct. 2, 2009

(30) Foreign Application Priority Data
Oct. 3, 2008 (TW) 097217794

(51) Int. Cl. H02J 1/00

(52) U.S. Cl. 307/31

(57) ABSTRACT

A power adaptor including a USB connector, a DC power input port, a DC power output port and a DC/DC voltage regulator. The DC power output port is electrically connected to the DC power input port. The DC/DC voltage regulator is electrically connected to the USB connector and the DC power input port for lowering the voltage of the power input from the DC power input port and outputting the power to the USB connector. The power adaptor is adaptable to a notebook computer charger to charge another portable electronic product such as a mobile phone, a PDA or an iPod. The charging process can be performed without powering on the notebook computer so as to facilitate use and save energy.

### BACKGROUND OF THE INVENTION

The present invention relates generally to a power adaptor, and more particularly to a power adaptor, which supplies part of input DC power for a USB connector to output.

Conventionally, when carrying a notebook computer 30 and another electronic product 10 (such as a mobile phone) outdoors, it is often necessary to additionally carry two kinds of charging transformers 40 (transformers and power cables) respectively for the notebook computer and the electronic product 10. In this case, the cables tend to tangle with each other. Moreover, the charging transformers have considerably heavy weights. Also, the cost for the charging transformers is increased.

Following the popularization of universal serial bus (hereinafter referred to in short as USB), the new type of notebook computer 30 is equipped with additional USB connection port 32 for providing higher current output and charging a portable electronic product chargeable via a USB power cable 11. The current output from the USB connection port of the current commercially available notebook computer is higher than the conventional device. However, due to the limitation of internal circuit design, most of the existing notebook computers still can only provide output current of about 500 mA. This can hardly satisfy the charging operation requiring high charging value per unit time or fast charging rate. In addition, at the present time, when using the USB connection port of the notebook computer to charge an externally connected electronic product, it is necessary to keep the notebook computer in a power-on state. That is, the USB connection port of the notebook computer cannot be solely used for charging the electronic product without powering on the notebook computer (as shown in FIG. 1).

A notebook computer charging transformer 40 equipped with a USB socket 42 is now available in the market. Another type of portable electronic product 10 is connectable to the USB socket 42 via a USB power cable 11 for charging the electronic product 10. However, it is necessary for a user to additionally purchase a notebook computer power connector 41 adapted to the transformer 40. This results in waster of resource and increment of cost. Moreover, with the USB socket 42 added to the charging transformer 40, the problem of electromagnetic interference must be taken into consideration when designing the internal circuit of the transformer. This leads to increment of cost for designing the internal circuit (as shown in FIG. 2).

It is therefore tried by the applicant to provide a power adaptor, which is able to provide sufficient USB power to another electronic product with the notebook computer in a power-off state. With the power adaptor, it is no more necessary for a user to additionally purchase a specific notebook computer charging transformer.

### SUMMARY OF THE INVENTION

It is therefore a primary object of the present invention to provide a power adaptor including a USB connector, a DC power input port, a DC power output port and a power supply regulator module. The power input from the DC power input port is partially transferred to the USB connector as subsidiary output. The DC power output port serves to provide main output of the input power.

The power supply regulator module can be a DC/DC voltage regulator for regulating (lowering) the voltage input from the DC power input port in adaptation to the necessary output voltage for the USB connector. The USB connector can be a plug, a socket or a cable plug. The DC power output port can be a plug or a cable plug.

In the power adaptor, the power supply regulator module can be alternatively a buck rectifier module. The power input from the DC power input port is partially transferred to the USB connector as subsidiary output. The DC power output port serves to provide main output of the input power. Also, the buck rectifier module serves to provide stable voltage and current output.

The buck rectifier module is composed of at least one DC/DC voltage regulator and at least one rectifier. The power adaptor further includes at least one voltage-stabilizing rectifier module for stabilizing the voltage and current output from the DC power output port.

The present invention can be best understood through the following description and accompanying drawings wherein:

### BRIEF DESCRIPTION OF THE DRAWINGS

FIG. 1 is a perspective view showing that the USB port of a notebook computer is used to charge another electronic product;

FIG. 2 is a perspective view showing that the USB socket of a transformer is used to charge another electronic product;

FIG. 3 is a perspective view showing that the power adaptor of the present invention is applied to a notebook computer charging transformer for charging another electronic product;

FIG. 4 is a perspective view showing the USB connector of the present invention in another aspect for connecting with an electronic product;

FIG. 5 is a block circuit diagram of a first embodiment of the present invention; and

FIG. 6 is a block circuit diagram of a second embodiment of the present invention.

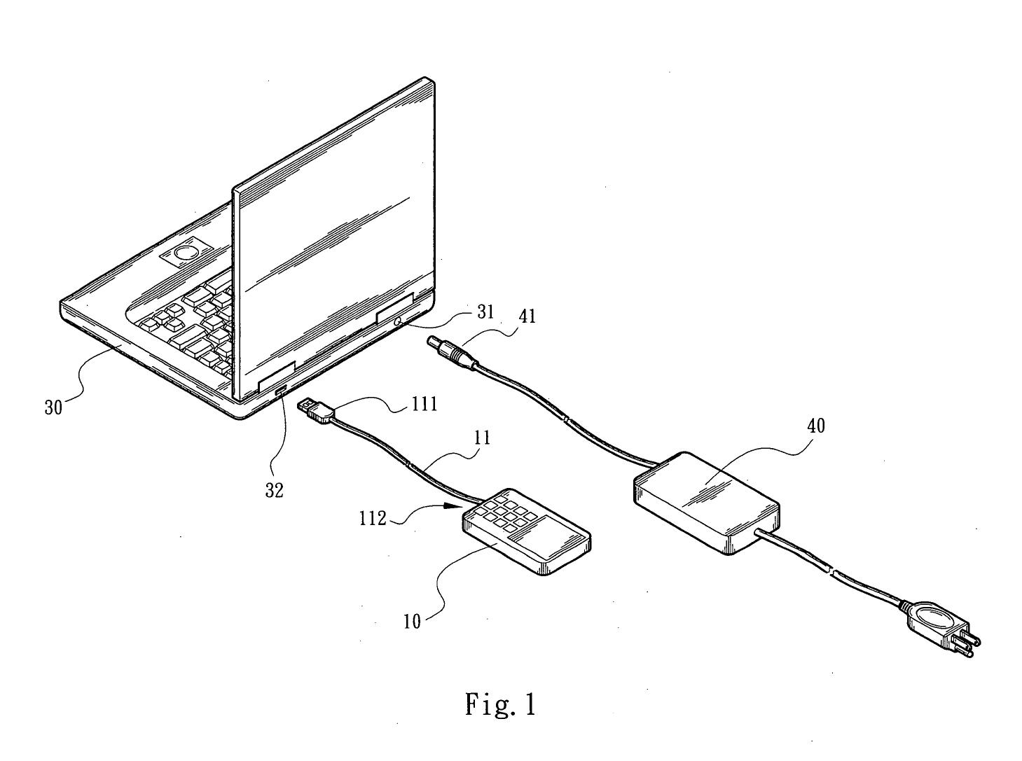

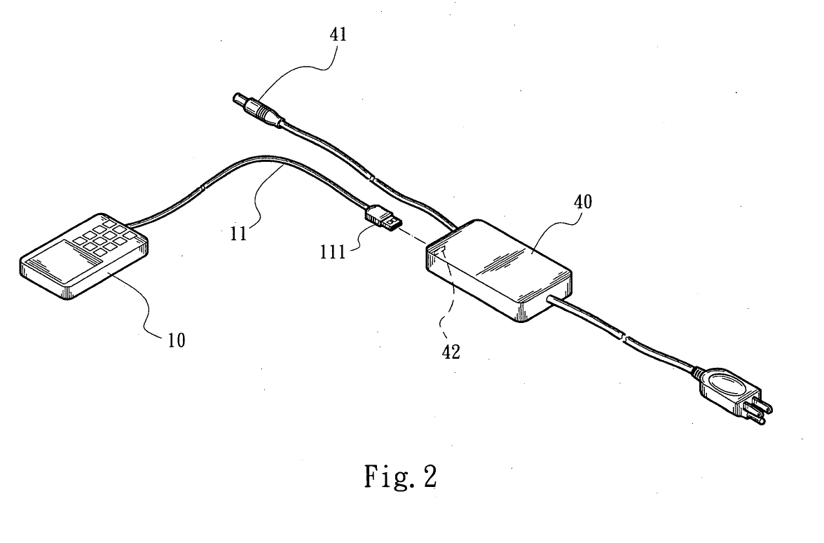

### DETAILED DESCRIPTION OF THE PREFERRED EMBODIMENTS

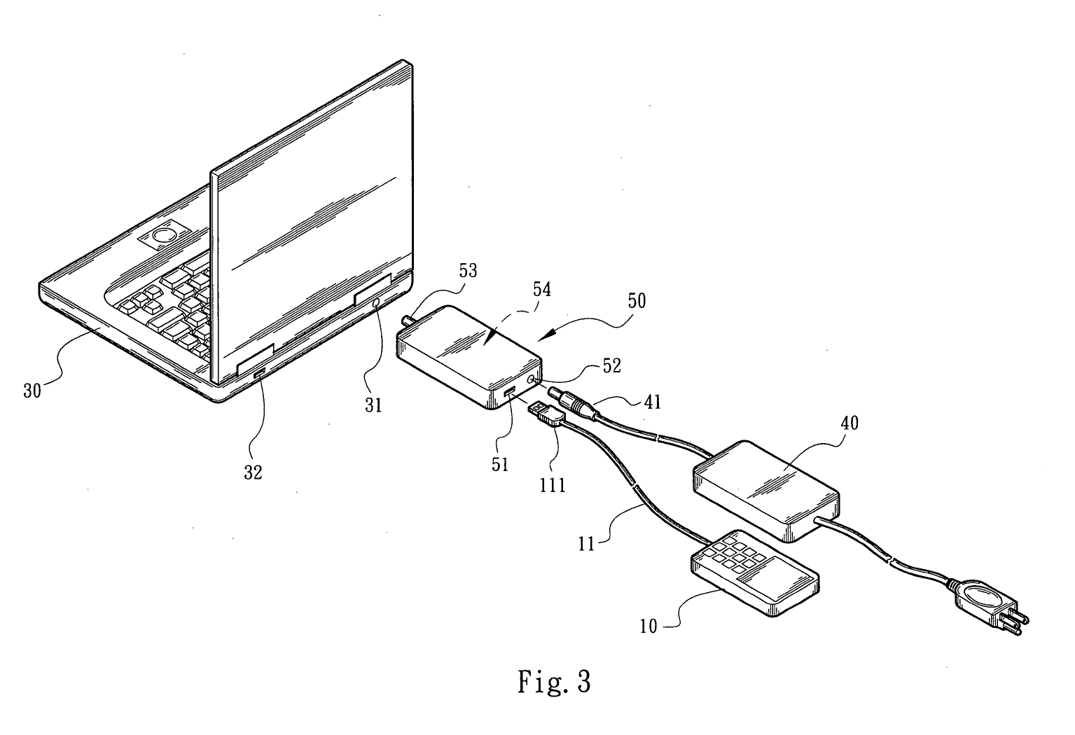

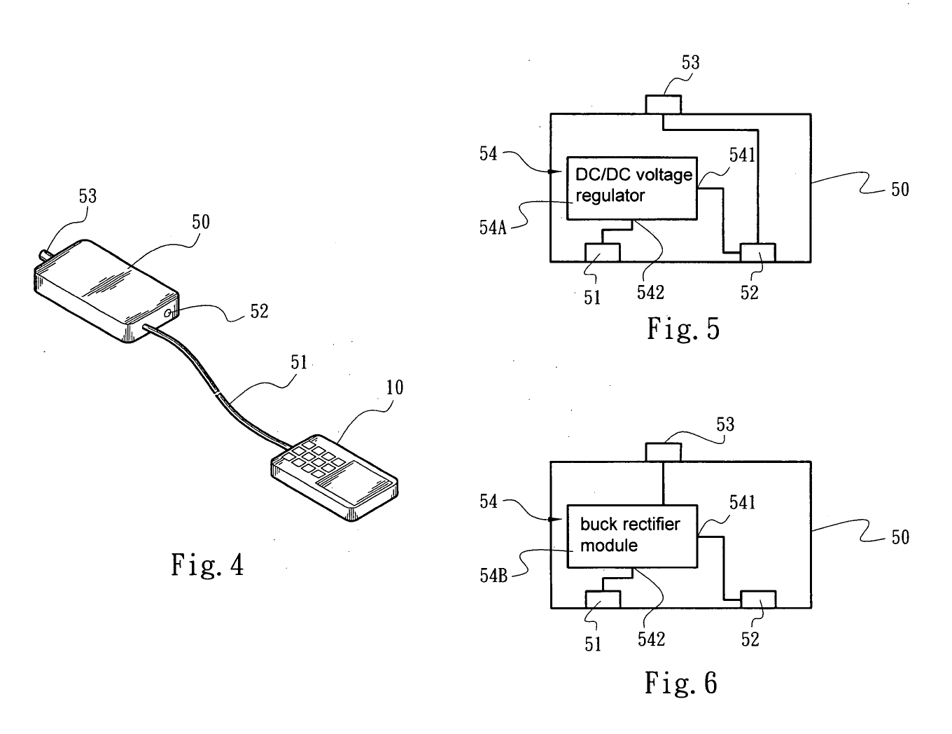

Please refer to FIGS. 3 and 5. According to a first embodiment, the power adaptor 50 of the present invention includes a USB connector 51, a DC power input port 52, a DC power output port 53 and a power supply regulator module 54. The power can be input from the DC power input port 52 and divided into main power and subsidiary power. The main power is directly electrically connected to the DC power output port 53. The subsidiary power is electrically connected to the USB connector 51. The power supply regulator module 54 can be a DC/DC voltage regulator 54A having an input terminal 541 and a subsidiary output terminal 542 (with reference to FIG. 4). The input terminal 541 is electrically connected to the DC power input port 52. The subsidiary output terminal 542 is electrically connected to the USB connector for lowering the voltage of the power input from the input terminal 541 and outputting the power to the subsidiary output terminal 542.

In this embodiment, the present invention is applied to a notebook computer (NB) charging transformer 40 as shown in FIG. 3. In use, the output power connector 41 of the notebook computer (NB) charging transformer 40 is plugged into the DC power input port 51. A plug 111 of a dual-plug USB cable 11 is plugged into the USB connector 51, (which is a USB socket in this embodiment). The other plug 112 of the dual-plug USB cable 11 is plugged into the power input port of another electronic product 10 to power or charge the electronic product 10. At the same time, the notebook computer is still continuously powered or charged via the DC power output port 53, (which can be a plug or a power cable plug).

Referring to FIG. 4, the USB connector 51 alternatively can be a USB plug or a cable USB plug. In use, the output power connector 41 of the charging transformer 40 is plugged into the DC power input port 52. The USB connector 51, (which is a USB plug or power plug in this embodiment), is plugged into the USB power input port of the electronic product 10 for powering or charging the same. At the same time, the notebook computer is still continuously powered or charged via the DC power output port 53, (which can be a plug or a power cable plug).

The DC power output port 53 selectively is a plug structure adapted to the input port 31 of the notebook computer 30. Alternatively, the DC power output port 53 can be a replaceable plug in adaptation to various power input ports 31. The DC power input port 52 can be also a replaceable one in adaptation to various output power connectors 41 of the charging transformer 40.

The DC/DC voltage regulator 54A can be a linear regulator or a switching regulator. The switching regulator can be a DC/DC converter or a switching controller in accordance with any different voltage and current requirement.

FIG. 6 shows a second embodiment of the power adaptor 50 of the present invention, which includes a USB connector 51, a DC power input port 52, a DC power output port 53 and a power supply regulator module 54 formed of a buck rectifier module 54B. The buck rectifier module 54B is composed of at least one DC/DC voltage regulator and at least one rectifier. The buck rectifier module 54B has an input terminal 541 and a subsidiary output terminal 542. The input terminal 541 is electrically connected to the DC power input port 52. The subsidiary output terminal 542 is electrically connected to the USB connector for lowering the voltage of the power input from the input terminal 541, rectifying the power and outputting the power to the subsidiary output terminal 542. Also, the DC power output port 53 can be electrically connected to the buck rectifier module 54B for rectifying the output power. In addition, the buck rectifier module 54B can further include a voltage-stabilizing rectifier module electrically connected between the DC power input port 52 and the DC power output port 53 for stabilizing the voltage and current of the output power.

The above embodiments are only used to illustrate the present invention, not intended to limit the scope thereof. Many modifications of the above embodiments can be made without departing from the spirit of the present invention.

What is claimed is:

1. A power adaptor comprising:
a DC power input port for inputting DC power, which is divided into main power and subsidiary power;
a USB connector electrically connected to the subsidiary power for outputting subsidiary current;
a DC power output port electrically connected to the main power for outputting main current; and
a power supply regulator module having an input terminal and a subsidiary output terminal, the input terminal being electrically connected to the DC power input port, while the subsidiary output terminal being electrically connected between the subsidiary power and the USB connector for outputting subsidiary current.

2. The power adaptor as claimed in claim 1, wherein the power supply regulator module is formed of a DC/DC voltage regulator.

3. The power adaptor as claimed in claim 2, wherein the DC/DC voltage regulator is a linear regulator.

4. The power adaptor as claimed in claim 2, wherein the DC/DC voltage regulator is a switching regulator.

5. The power adaptor as claimed in claim 4, wherein the switching regulator is a switching controller.

6. The power adaptor as claimed in claim 4, wherein the switching regulator is a DC/DC converter.

7. The power adaptor as claimed in claim 1, wherein the power supply regulator module is formed of a buck rectifier module.

8. The power adaptor as claimed in claim 7, wherein the buck rectifier module is composed of at least one DC/DC voltage regulator and at least one rectifier.

9. The power adaptor as claimed in claim 7, further comprising at least one voltage-stabilizing rectifier module electrically connected between the DC power input port and the DC power output port for stabilizing the voltage and current of the output power.

10. The power adaptor as claimed in claim 9, wherein the voltage-stabilizing rectifier module is arranged in the buck rectifier module.

11. The power adaptor as claimed in any of claims 1, wherein the DC power output port and the DC power input port are electrically connected to each other via a power cable.

12. The power adaptor as claimed in any of claims 2, wherein the DC power output port and the DC power input port are electrically connected to each other via a power cable.

13. The power adaptor as claimed in any of claims 7, wherein the DC power output port and the DC power input port are electrically connected to each other via a power cable.

14. The power adaptor as claimed in any of claims 8, wherein the DC power output port and the DC power input port are electrically connected to each other via a power cable.

15. The power adaptor as claimed in any of claims 9, wherein the DC power output port and the DC power input port are electrically connected to each other via a power cable.

16. The power adaptor as claimed in any of claims 1, wherein the DC power output port has a plug structure.

17. The power adaptor as claimed in any of claims 2, wherein the DC power output port has a plug structure.

18. The power adaptor as claimed in any of claims 7, wherein the DC power output port has a plug structure.

19. The power adaptor as claimed in any of claims 8, wherein the DC power output port has a plug structure.

20. The power adaptor as claimed in any of claims 9, wherein the DC power output port has a plug structure.

21. The power adaptor as claimed in any of claims 1, wherein the DC power output port has a power cable and a plug structure at one end thereof.

22. The power adaptor as claimed in any of claims 2, wherein the DC power output port has a power cable and a plug structure at one end thereof.

23. The power adaptor as claimed in any of claims 7, wherein the DC power output port has a power cable and a plug structure at one end thereof.

24. The power adaptor as claimed in any of claims 8, wherein the DC power output port has a power cable and a plug structure at one end thereof.

25. The power adaptor as claimed in any of claims 9, wherein the DC power output port has a power cable and a plug structure at one end thereof.

26. The power adaptor as claimed in any of claims 1, wherein the USB connector has a plug structure.

27. The power adaptor as claimed in any of claims 2, wherein the USB connector has a plug structure.

28. The power adaptor as claimed in any of claims 7, wherein the USB connector has a plug structure.

29. The power adaptor as claimed in any of claims 8, wherein the USB connector has a plug structure.

30. The power adaptor as claimed in any of claims 9, wherein the USB connector has a plug structure.

31. The power adaptor as claimed in any of claims 1, wherein the USB connector has a power cable and a plug structure at one end thereof.

32. The power adaptor as claimed in any of claims 2, wherein the USB connector has a power cable and a plug structure at one end thereof.

33. The power adaptor as claimed in any of claims 7, wherein the USB connector has a power cable and a plug structure at one end thereof.

34. The power adaptor as claimed in any of claims 8, wherein the USB connector has a power cable and a plug structure at one end thereof.

35. The power adaptor as claimed in any of claims 9, wherein the USB connector has a power cable and a plug structure at one end thereof.

36. The power adaptor as claimed in any of claims 1, wherein the USB connector has a socket structure.

37. The power adaptor as claimed in any of claims 21, wherein the USB connector has a socket structure.

38. The power adaptor as claimed in any of claims 7, wherein the USB connector has a socket structure.

39. The power adaptor as claimed in any of claims 8, wherein the USB connector has a socket structure.

40. The power adaptor as claimed in any of claims 9, wherein the USB connector has a socket structure.

41. The power adaptor as claimed in any of claims 1, wherein the DC power input port is connectable to an output terminal of a charging transformer.

42. The power adaptor as claimed in any of claims 2, wherein the DC power input port is connectable to an output terminal of a charging transformer.

43. The power adaptor as claimed in any of claims 7, wherein the DC power input port is connectable to an output terminal of a charging transformer.

44. The power adaptor as claimed in any of claims 8, wherein the DC power input port is connectable to an output terminal of a charging transformer.

45. The power adaptor as claimed in any of claims 9, wherein the DC power input port is connectable to an output terminal of a charging transformer.
